(19) United States
(12) Patent Application Publication
(10) Pub. No.: US 2007/0254274 A1
(43) Pub. Date: Nov. 1, 2007

(54) CLASS LOCATER SYSTEM

(76) Inventor: Kyle J. Graham, Riverview, FL (US)

Correspondence Address: Law Office of J. D. Pemberton;John D. Pemberton, 7405 Buckskin Court, Fort Worth, TX, 76137, US

(21) Appl. No.: 11/740,917

(22) Filed: Apr. 26, 2007

Related U.S. Application Data
(60) Provisional application No. 60/745,681, filed on Apr. 26, 2006.

(51) Int. Cl. G09B 3/00

(52) U.S. Cl. 434/322

(57) ABSTRACT

A system that performs the tedious search for an opening in a previously closed class on the student's behalf and once the system determines the closed class is accepting a new student, the system then notifies the student about the opening via cell phone, email, text message, or any other method the user desires.

### CLAIM OF PRIORITY

This application claims the benefit of U.S. Provisional Application No. 60/745,681 filed Apr. 26 2006 which is incorporated herein by reference.

### BACKGROUND OF THE INVENTION

1. Technical Field

The object of the invention is to provide a method of searching and registering for a class and more particularly to determine when a previously unavailable class becomes available for selection by a student.

2. Description of Related Art

In most schools students are allowed to register for the classes they wish to take via an online system. Typically, the registration process occurs at the end of each semester or term and there is a mad dash by the students to register for the most popular classes. As a result, during the relatively short registration period, many classes quickly become full leaving the unlucky student who was unable to register for a class waiting until somebody drops or withdraws from the class, the class begins to accept more students, or a new class is created. Typically, the unlucky student must wait by a computer and continually try to register for the full class hoping that they would be first to know when someone withdraws or the class begins to accept more students. If there are several students repeatedly checking and rechecking to see if a class can accept a new student, the university's registration system can become overused and problems may occur.

The current process of registering for classes is very tedious and inefficient and may cause problems for students during the registration period including delaying the graduation date of the student. Also, some students are unable to wait by a computer and are forced to select another less desirable class. What is needed is a system or method that allows the tedious search for an opening in a class to be performed on the student's behalf and once the system or method determines that the closed class has an opening, it will notify the student about the opening.

### SUMMARY OF INVENTION

The present invention is a system that performs the tedious search for an opening in a previously closed class on the student/user's behalf and once the system determines the closed class is accepting a new student, the system then notifies the user about the opening via cell phone, email, text message, or any other method the user desires. It should be noted that the words student and user may be used interchangeably.

The system comprises a frontend and a backend. The frontend is controlled by a web interface that allows a user to set up and obtain live information about any search that the software is performing. After signing up on the system, the user inputs the class that they are interested in. Once the user inputs the class, the backend takes over and repeatedly searches for an opening in the closed class until an opening is found. Once an opening in the previously closed class is found, then the system notifies the user about the opening.

The frontend contains two components, or interfaces, an administrative interface and a student interface. Both the administrative interface and the student interface may be web based. The administrative interface is for an administrator of the system such as a university administrator. The administrative interface allows the administrator to control the look, feel, and functionality of the system. The administrative interface presents a “face” to the class locater backend system and allows configuration and testing of items including but not limited to: class locater search frequency, database connectivity options, statistical views, ability to test specific features such as the test of an actual phone call when a class opens or text-to-speech testing and settings, view the active status of the system, log files, upgrade information, and control of the system's aesthetics displayed to the students. By way of example and not of limitation, the system's aesthetics may include the school colors and/or logo.

In addition, through the administrative interface, the system can provide accurate supply & demand tracking system for classes by keeping statistics on what classes are regularly becoming full or closed. Using this data, an administrator can know what classes are in high demand and by knowing what classes are in high demand, administrators can plan class schedules more efficiently. In one embodiment, if a minimum number of students are trying to register for a class that is closed, the system can open a new class similar to the class that is closed. The system can be programmed even further to automatically notify and secure teachers about the newly opened class and book rooms with appropriate size capacity to accommodate the students trying to register for the closed class.

The student interface is the interface that the students see and it allows them to control what classes the system searches for and how the student will be notified when there is an opening in the class. The student interface is a web based interface that the students use when registering for classes. It allows them to enter the classes or reference numbers to the classes they want to search for as well as the specific contact information that the class locater system will use to make contact when a class becomes available. From the student interface, users can also see the status of any search.

In one embodiment, the system will notify students when information has changed about a class they are registered for. For example, if the room or teacher changes, more students are allowed to register for the class, or an alternative class is opened, then the students registered for the class would get a message notifying them of the change. The notification may include, but is not limited to a telephone call, cell phone call, pager, text message, fax number, e-mail address, posting on a bulletin board system, or instant message (IM).

The backend system is configured from the administrative interface and the student web based interface. The backend system is the component that performs the searching for available classes as well as contacting a student when a class becomes available. In one embodiment, the backend system and search algorithm are customized for each university's system. The backend system can be programmed to search in a number of ways such as directly from the university's public access website, from the university's private class database using any number of database technologies such as MS Access, MS SQL Server, MySQL, or any other method that will allow the system to search for available classes.

Other features and advantages of the present invention will become apparent upon reading the following detailed description of embodiments of the invention, when taken in conjunction with the appended claims.

### BRIEF DESCRIPTION OF THE DRAWINGS

FIG. 1 is a flow diagram depicting the steps used in the frontend portion of the system in accordance with an embodiment of the present invention.

FIG. 2 is a flow diagram depicting the steps used in the backend portion of the system in accordance with an embodiment of the present invention.

### DETAILED DESCRIPTION OF THE INVENTION

In the following detailed description, reference is made to the accompanying drawings that form a part hereof, and in which is shown by way of illustration, specific embodiments in which the invention may be practiced. These embodiments are described in sufficient detail to enable those skilled in the art to practice the invention, and it is to be understood that other embodiments may be utilized. It is also to be understood that structural, procedural and system changes may be made without departing from the spirit and scope of the present invention. The following detailed description is, therefore, not to be taken in a limiting sense, and the scope of the present invention is defined by the appended claims and their equivalents. For clarity of exposition, like features shown in the accompanying drawings are indicated with like reference numerals and similar features as shown in alternate embodiments in the drawings are indicated with similar reference numerals.

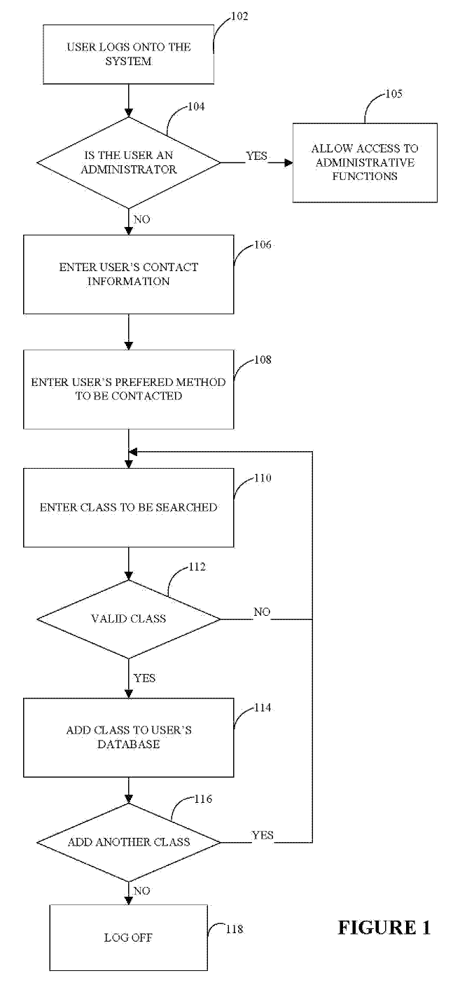

Before the system can be used by a student, the system must be configured by an administrator. First, an administrator with a computer accesses the system through the Internet, LAN, WAN, or some other type of network. To configure the system, an administrator links the system to the school's database of classes. In addition, the administrator may configure the aesthetics of the system such as the look, feel, and functionality of the system. In one embodiment, as shown in FIG. 1, the administrative interface is accessed through the same interface as a student would access the system. In another embodiment, the administrative interface is separate from the student interface.

Once the system is linked to the school's database of classes, students may log onto the system and configure the system to automatically search for an opening in a closed class. As shown in FIG. 1, the first step for a student to configure the system to automatically search for an opening in a closed class is to log onto the system, Step 102. Next the system determines if the user is an administrator, Step 104. If the system determines the user is an administrator, then the system allows the user to access the administrative functions of the system, Step 105.

The administrative functions include, but are not limited to controlling access to the system, the classes the system is linked to in the school's class database, providing a link or access to an already existing database of classes to determine whether or not a particular class is available to students, the search frequency used to determine if a class is available, database connectivity options, statistical views, ability to test specific features such as the test of an actual phone call when a class opens, ability to set text-to-speech testing and functions, view the active status of the system, log files, update or upgrade information, control of student interface colors, and content to allow creation of a branded version such as adding school colors, or logos, as well as other aspects relating to the look, feel, and functionality of the system. In one embodiment, the administrative section of the system is web based and allows configuration and testing of the system.

In another embodiment, the system can be configured such that if a minimum number of students are trying to register for a class that is closed, the system can automatically open a new class similar to the class that is closed. The system can be configured even further to automatically secure teachers and notify the teachers about the newly opened class and book a room with the appropriate size capacity to accommodate the students trying to register for the closed class.

If the system determines the user is not an administrator, then the system allows the user to enter contact information, Step 106. By way of example and not of limitation, the contact information may include a telephone number, cell phone number, pager, text message, fax number, e-mail address, posting on a bulletin board system, or instant message (IM).

After the user has entered contact information, the system allows the user to enter the preferred method of contact, Step 108. If the system cannot contact the user by the preferred method of contact, then the system will attempt to contact the user by other methods of contact that were entered into the system. The methods of contact may include, but are not limited to, telephone call, cell phone call, pager, text message, fax number, e- mail address, posting on a bulletin board system, or instant message (IM). After the user has entered the contact method, the system allows the user to enter the desired class the user may want to take, Step 110.

Next, the system determines if the entered class is a valid class, Step 112. In one embodiment, the system uses a main school database to determine if the class is valid. For example, if the class is in the main school database and is listed as being offered, then the system may determine that the class is valid. If the system determines the class is not a valid class, then the system returns to Step 110 and allows the user to enter the desired class the user may want to take. If the system determines the class is a valid class, then the system adds the class to the user's database, Step 114. Next, the system determines if the user wants to enter another class that the user may want to take, Step 116. If the system determines the user wants to enter another class, then the system returns to Step 110 and allows the user to enter another class. If the system determines that the user does not want to enter another class, then the system logs the user off, Step 118.

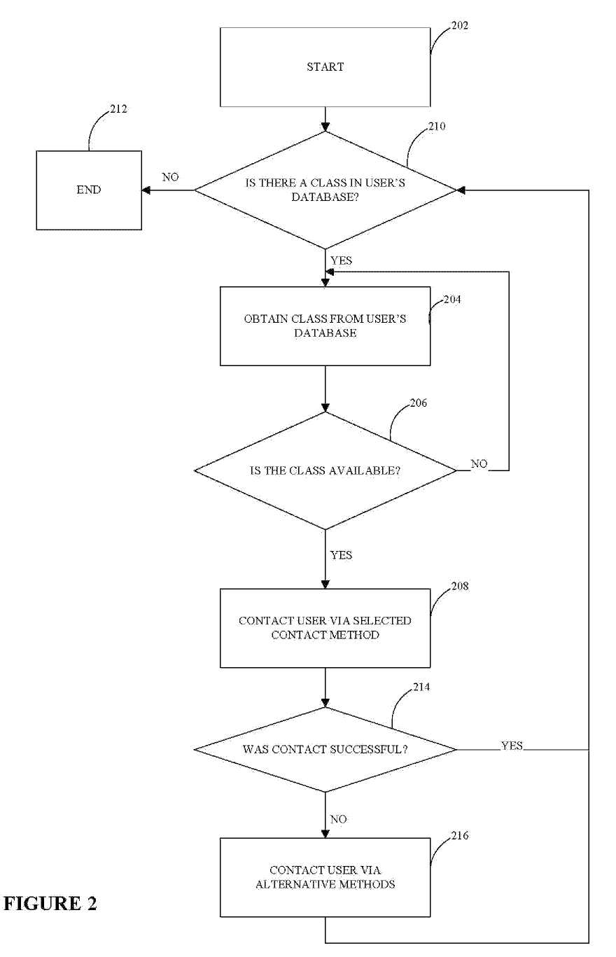

The backend of the system, as shown in FIG. 2 begins when the system starts the backend process, Step 202. The backend of they system performs the searching for available classes as well as contacting a student when a class becomes available. In one embodiment, the backend system and search algorithm are customized for each university's system. The backend system can be programmed to search in a number of ways such as directly from the university's public access website, from the university's private class database using any number of database technologies such as access or MS Access, MS SQL Server, MySQL, or any other method that will allow the system to search for available classes.

The system may start the backend process when the system is activated or may start the backend process at a specific time each day or only during specific hours of the day. In addition, the frequency of when the system checks for an open class can be set by an administrator. For example, the frequency may be set at 1 second, 1 minute, 1 hour, or almost any other frequency. In one embodiment, the frequency is set as fast as the process will allow and may even be less than one second. In another embodiment the periodic interval is greater than about 0.5 seconds.

Next, the system determines if a class is in a student's database, Step 210. If the system determines that a class is not in a student's database, then the system stops the backend process for that student and checks a different student to see if a class is in that student's database. If the system determines that a class is in the student's database, then the system obtains the class that is in the student's database, Step 204. A class is in a student's database if the student entered the class into the system in Step 110.

After the system obtains the class, the system determines if the class is available, Step 206. The system determines if the class is available by checking the school's database of classes to see if there is an opening in the specific class. If the system determines the class is not available, then the system returns to Step 204 and if multiple classes are in the user's database, then the system obtains the next class. If multiple classes are not in the user's database, then the system obtains the same class and checks to see if the class is available, Step 206. If the system determines the class is available, then the system contacts the user by the preferred method of contact entered in Step 108, Step 208. In another embodiment, after the system determines the class is available, the system automatically registers the student for the class.

Next, the system determines if the contact was successful, Step 214. The system determines the contact was successful if the telephone or cell phone call was made, pager, text message, fax, e-mail or instant message (IM) was sent or a posting on a bulletin board system was made. If the system determines that the contact was not successful, then the system attempts to contact the student by alternative methods, Step 216.

After the system has successfully contacted the student or the system has attempted to contact the student by alternative methods, the system determines if any classes remain in the student's database, Step 210. If the system determines that a class remains in the student's database, then the system returns to Step 204 and obtains the next class. If the system determines that there are not any classes remaining in the student's database, then the system ends the backend portion of the system for that particular student, Step 212.

In one embodiment, the system will notify a student when information about a class they are registered for has changed. For example, if the room or teacher changes, more students are allowed to register for the class, or an alternative class is opened, then the students registered for the class would get a message notifying them of the change. The notification may include, but is not limited to a telephone call, cell phone call, pager, text message, fax number, e-mail address, posting on a bulletin board system, or instant message (IM). In another embodiment, the user has the option of whether or not they want to receive notification if information about the class they have registered for has changed.

In another embodiment, the system is not used to notify a student when a previously closed class becomes available but is used to notify a buyer when an apartment from a particular apartment complex is available for rent. In this embodiment, the system works similar to the one described above except the administrator is an employee or agent of the apartment complex and the user is a person wanting to rent an apartment in the complex. The employee or agent of the apartment complex configures the system similar to that described above. The person wanting to rent an apartment enters the apartment information and contact method similar to the way the student would enter the class and contact information. Then, when the apartment becomes available, the system contacts the person wanting to rent the apartment in the manner that they entered into the system. It should be obvious to those skilled in the art that they system could be used in other areas to notify a person when specific information contained in a database changes to a specific condition such as a class or an apartment becoming available or when a stock falls below a specific price, a sports team does something news worth, or any other event that a person may want to be notified about when a specific condition happens to specific information.

It should be understood that the foregoing relates to exemplary embodiments of the invention and that modifications may be made without departing from the spirit and scope of the invention as set forth in the following claims.

What is claimed is:

1. A method for alerting a student at a university when a previously unavailable class at the university is available, the method comprising the steps of:
configuring a system to link with a class database at a university;
allowing a student to select a class from the class database;
determining if the class is available;
conditioned on the class being unavailable, checking at a periodic interval to see if the selected unavailable class is available; and
conditioned upon the class being available, alerting the student that the selected class is available.

2. The method of claim 1 where the alert is a telephone call, cell phone call, pager, text message, fax number, e-mail address, posting on a bulletin board system, or instant message (IM).

3. The method of claim 1 wherein the periodic interval is greater than about 0.5 seconds.

4. The method of claim 1 wherein the system contains an administrative function.

5. The method of claim 1 wherein the system is web based.

6. The method of claim 1 wherein after the class is available, the system registers the student automatically.

7. The method of claim 1 further comprising the step of alerting the student when information about a class the student is registered for changes.

8. The method of claim 1 wherein the system can be configured such that if a minimum number of students are trying to register for a class that is closed, the system can automatically open a new class similar to the class that is closed.

9. The method of claim 8 wherein once the new class is opened, the system automatically notifies teachers about the newly opened class and books a room with the appropriate size capacity to accommodate the students for the new class.

10. A system that will alert a student at a university when a previously unavailable class at the university is available, the system comprising:
a frontend wherein the frontend contains an administrative portion and a student portion wherein
the administration portion allows an administrator to configuring the system to link with a class database at a university, set the search frequency used to determine if a class is available, set database connectivity options, access statistical views related to the system, test features of the system, view the active status of the system, view log files, update information, and control the look of the system;
the student portion allows a student to select a class from the class database and the contact method to be used when the selected class becomes available; and
a backend portion wherein the backend portion determines if the selected class is available and if the class is not available, the backend portion checks at a periodic interval to see if the selected class is available then, once the selected class is available, alerting the student that the selected class is available.

11. The system of claim 10 wherein the alert is a telephone call, cell phone call, pager, text message, fax number, e-mail address, posting on a bulletin board system, or instant message (IM).

12. The system of claim 10 wherein the periodic interval is greater than about 0.5 seconds.

13. The system of claim 10 wherein the system is web based.

14. The system of claim 10 wherein after the class is available, the system registers the student automatically.

15. The system of claim 10 wherein the backend of the system will also alert the student when information about a class the student is registered for changes.

16. The system of claim 10 wherein the backend of the system is configured such that if a minimum number of students are trying to register for a class that is closed, the system can automatically open a new class similar to the class that is closed.

17. The system of claim 16 wherein once the new class is opened, the system automatically notifies teachers about the newly opened class and books a room with the appropriate size capacity to accommodate the students for the new class.

18. A method for alerting a user when a previously unavailable condition is met, the method comprising the steps of:
configuring a system to link to a database having information wherein at least a portion of the information changes conditions;
allowing a user to select a condition related to specific information in the database;
determining if the specific information meets the selected condition;
conditioned on the specific information not meeting the selected condition, checking at a periodic interval to see if specific information meets the selected condition; and
conditioned upon the specific information meeting the selected condition, alerting the user that the specific information meets the selected condition.

19. The method of claim 18 where the alert is a telephone call, cell phone call, pager, text message, fax number, e-mail address, posting on a bulletin board system, or instant message (IM).

20. The system of claim 18 wherein the system is web based.
